(19) United States
(12) Patent Application Publication
(10) Pub. No.: US 2024/0157300 A1
(43) Pub. Date: May 16, 2024

(54) METHOD FOR CONTROLLING ELECTRODEIONIZATION DEVICE

(71) Applicant: KURITA WATER INDUSTRIES LTD., Tokyo (JP)

(72) Inventors: Rena TABEI, Tokyo (JP); Yasuharu MINATO, Tokyo (JP)

(73) Assignee: KURITA WATER INDUSTRIES LTD., Tokyo (JP)

(21) Appl. No.: 18/280,657

(22) PCT Filed: Mar. 9, 2022
(86) PCT No.: PCT/JP2022/010171

§ 371 Date: Sep. 6, 2023

(30) Foreign Application Priority Data
Mar. 22, 2021 (JP) 2021-047988

(51) Int. Cl. B01D 61/48; B01D 61/54

(52) U.S. Cl. CPC B01D 61/48; B01D 61/54

(57) ABSTRACT

The control method for an electrodeionization device (1) of the present invention includes stepwise decreasing the flow rate of supply water (W1) supplied to the electrodeionization device (1) while maintaining a constant flow rate of concentrated water (W5) discharged from the electrodeionization device (1). With such a control method for an electrodeionization device, even when the flow rate of the supply water supplied to the electrodeionization device is decreased, it is possible to prevent an increase in the electrical conductivity, thereby suppressing the occurrence of scale.

### TECHNICAL FIELD

The present invention relates to a control method for an electrodeionization device.

### BACKGROUND ART

Conventionally, ultrapure water used in the electronic industry fields such as a semiconductor field is produced by processing raw water with an ultrapure water production apparatus composed of a pretreatment system, a primary pure water production device, and a secondary pure water production device (subsystem) that processes the primary pure water.

The primary pure water production device included in such an ultrapure water production apparatus is a highly versatile system that is used in various fields such as those for pharmaceuticals and foods in addition to the field of ultrapure water production apparatuses. The configuration of the primary pure water production device is generally a two-stage configuration composed of a reverse osmosis membrane (RO membrane) device and an electrodeionization device. The reverse osmosis membrane (RO membrane) device removes silica and salts and also removes ionic and colloidal TOC.

Here, the electrodeionization device generally has a configuration in which cation exchange membranes and anion exchange membranes are alternately arranged between a cathode and an anode to alternately form desalting chambers and concentrating chambers and the desalting chambers are filled with ion exchange resin, and performs removal of various inorganic or organic anions and cations.

When water is supplied to the desalting chambers of the electrodeionization device, ions in the water migrate in the desalting chambers toward the ion exchange resin of either the anode or the cathode due to the electrical charge. The migrated ions pass through the ion exchange resin and enter the concentrating chambers, so highly desalted pure water is produced in the desalting chambers. On the other hand, ions migrated to the concentrating chambers are discharged as concentrated water.

Electrodeionization devices have been operated under constant supply conditions for supply water to the electrodeionization devices from the viewpoint of stably producing the primary pure water having a predetermined water quality. To this end, the operation has been performed such that the primary pure water produced in the primary pure water production device including the electrodeionization device is supplied in a necessary amount to a sub-tank of the secondary pure water production device while the surplus primary pure water produced is circulated an used in the primary pure water production device.

### SUMMARY OF THE INVENTION

### Problems to be Solved by the Invention

In the conventional operation method for the primary pure water production device as described above, however, there is room for improvement in terms of the energy efficiency because the electrodeionization device or the like is supplied with more water than necessary for processing. In this regard, it is conceivable to vary the processing amount of the electrodeionization device in accordance with the necessary amount of the primary pure water, but if the flow rate of supply water supplied to the electrodeionization device is instantaneously decreased during the operation of the electrodeionization device, the electrical conductivity of the concentrated water will temporarily increase. When the electrical conductivity of the concentrated water increases, the ion concentration in the concentration chambers increases, thus leading to a problem in that scale is likely to occur.

The present invention has been made in view of the above problem, and an object of the present invention is to provide a control method for an electrodeionization device that prevents an increase in the electrical conductivity even when the flow rate of supply water supplied to the electrodeionization device is decreased, thereby suppressing the occurrence of scale.

### Means for Solving the Problems

In view of the above object, the present invention provides a control method for an electrodeionization device, comprising stepwise decreasing a flow rate of supply water supplied to the electrodeionization device while maintaining a constant flow rate of concentrated water discharged from the electrodeionization device (Invention 1).

According to the invention (Invention 1), the increase in the electrical conductivity of the concentrated water can be prevented by stepwise decreasing the flow rate of the supply water supplied to the electrodeionization device while maintaining a constant flow rate of the concentrated water discharged from the electrodeionization device, and it is thereby possible to suppress the occurrence of scale.

In the above invention (Invention 1), the flow rate of the supply water to be decreased in one step may be 10% or less of a maximum flow rate in the electrodeionization device (Invention 2).

In the above invention (Invention 1 or 2)), a time for one step when stepwise decreasing the flow rate of the supply water may be 1 to 10 minutes (Invention 3).

In the above invention (Invention 1 to 3)), the flow rate of the supply water supplied to the electrodeionization device may be stepwise decreased by PID control (Invention 4).

### Advantageous Effect of the Invention

According to the present invention, it is possible to provide a control method for an electrodeionization device that prevents an increase in the electrical conductivity even when the flow rate of the supply water supplied to the electrodeionization device is decreased, thereby suppressing the occurrence of scale.

### BRIEF DESCRIPTION OF DRAWINGS

FIG. 1 is a flow diagram illustrating an ultrapure water production apparatus to which the control method for an electrodeionization device according to the present invention can be applied.

FIG. 2 is a schematic diagram illustrating the control structure of an electrodeionization device in the control method for an electrodeionization device according to the present invention.

FIG. 3 is a schematic diagram illustrating an electrodeionization device used in the control method for an electrodeionization device according to the present invention.

FIG. 4 is a schematic diagram illustrating the water flow state of an electrodeionization device used in the control method for an electrodeionization device according to the present invention.

FIG. 5 is a schematic diagram illustrating the control structure of an electrodeionization device of Example 1.

FIG. 6 is a graph illustrating changes in the electrical conductivity (mS/m) per elapsed time of the concentrated water discharged from the electrodeionization device in Example 1.

FIG. 7 is a graph illustrating changes in the electrical conductivity (mS/m) per elapsed time of the concentrated water discharged from the electrodeionization device in Comparative Example 1.

FIG. 8 is a graph illustrating changes in the electrical conductivity (mS/m) per elapsed time of the concentrated water discharged from the electrodeionization device in Comparative Example 2.

FIG. 9 is a graph illustrating changes in the electrical conductivity (mS/m) per elapsed time of the concentrated water discharged from the electrodeionization device in Comparative Example 3.

### EMBODIMENTS FOR CARRYING OUT THE INVENTION

Hereinafter, the control method for an electrodeionization device of the present invention will be described with reference to the accompanying drawings. For descriptive purposes, the description will be made partially using a diagram in which the electrodeionization device is provided in an ultrapure water production apparatus, but the control method for an electrodeionization device in the present invention can be used not only in the ultrapure water production apparatus but also in various fields such as those for pharmaceuticals and foods.

### (Electrodeionization Device)

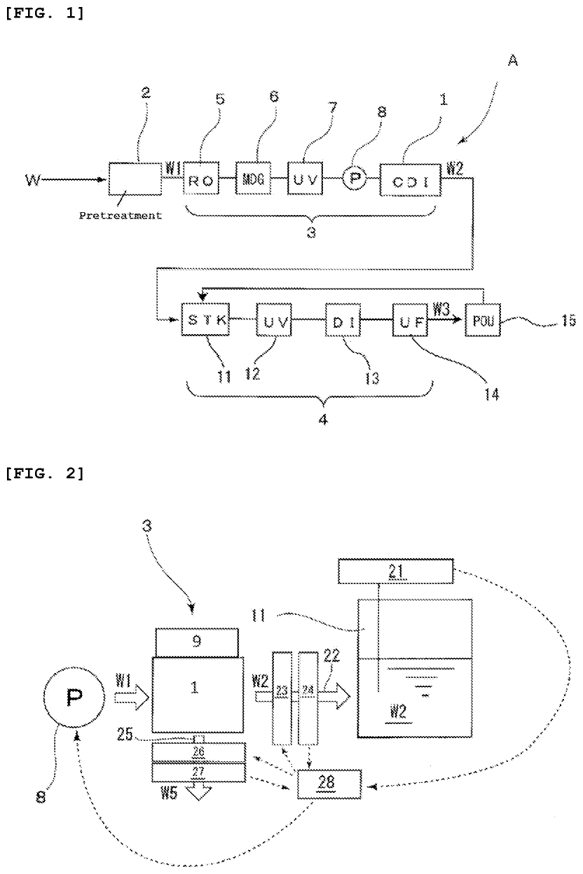

FIG. 1 is a diagram illustrating an ultrapure water production apparatus A that can carry out the control method for an electrodeionization device 1 according to an embodiment of the present invention. As illustrated in FIG. 1, the ultrapure water production apparatus A may be composed of three-stage devices of a pretreatment device 2, a primary pure water production device 3, and a secondary pure water production device (subsystem) 4. The primary pure water production device 3 includes the electrodeionization device 1 (denoted as CDI in FIG. 1). In the pretreatment device 2 of such an ultrapure water production apparatus A, the pretreatment may be performed, such as by filtration of raw water W, coagulation sedimentation, and microfiltration, to primarily remove suspended solids.

The primary pure water production device 3 may have a reverse osmosis membrane device 5 that processes pretreated water (also referred to as supply water, here and hereinafter) W1, a degassing membrane device 6, an ultraviolet oxidation device 7, the electrodeionization device 1, and a water supply pump 8 that supplies the pretreated water W1 to the electrodeionization device 1. The primary pure water production device 3 may remove most of the electrolytes, fine particles, viable bacteria, etc. in the pretreated water W1 and decompose organic substances.

The subsystem 4 may be composed of a sub-tank 11 that serves as a water storage tank arranged downstream the above electrodeionization device 1 and stores desalted water (which corresponds to primary pure water, here and hereinafter, because the electrodeionization device 1 is provided at the end of the primary pure water production device 3 in the present embodiment) W2 produced in the primary pure water production device 3, an ultraviolet oxidation device 12 that processes the primary pure water W2 supplied from the sub-tank 11 via a pump (not illustrated), a non-regenerative mixed bed type ion exchange device 13, and an ultrafiltration (UF) membrane 14 as a membrane filtration device. In some cases, an RO membrane separator or the like may be further provided as required. In this subsystem 4, a small amount of organic substances (TOC components) contained in the primary pure water W2 may be oxidized and decomposed by the ultraviolet oxidation device 12 and subsequently processed in the non-regenerative mixed bed type ion exchange device 13, in which residual carbonated ions, organic acids, anionic substances, metal ions, cationic substances, etc. are removed by ion exchange. Then, the ultrafiltration (UF) membrane 14 may remove fine particles to obtain ultrapure water W3, and this may be supplied to a point of use 15. Unused ultrapure water W3 may be flowed back to the sub-tank 11.

In the present embodiment, as illustrated in FIG. 2, the primary pure water production device 3 is provided with the water supply pump 8 for controlling the flow rate of the supply water W1 to the electrodeionization device 1, while the electrodeionization device 1 in communication with the water supply pump 8 is provided with a DC power supply 9A, and the desalted water W2 from the electrodeionization device 1 can be supplied to the sub-tank 11 as a water storage tank that is arranged downstream the electrodeionization device 1.

Flow path 25 for concentrated water W5 from the electrodeionization device 1 may be provided with a control valve 26 and a flowmeter 27 for arbitrarily controlling the flow rate of the concentrated water W5. Likewise, flow path 22 for the desalted water W2 from the electrodeionization device 1 may be provided with a control valve 23 and a flowmeter 24.

Control device 28 provided with a personal computer or the like can control the water supply pump 8 thereby to increase or decrease the flow rate of the supply water W1 to the electrodeionization device 1 and can also control the control valve 23 and the control valve 26 thereby to arbitrarily increase or decrease the flow rate of the flow path 22 and/or the flow path 25. In addition, the control device 28 may be configured such that the measurement data can be transmitted to it from each of the flowmeter 24 and the flowmeter 27. The sub-tank 11 may be provided with a level switch 21 that measures the amount of water stored in the sub-tank 11, and the production amount of the desalted water W2 may be controlled in accordance with the measurement data of the amount of water stored in the sub-tank 11.

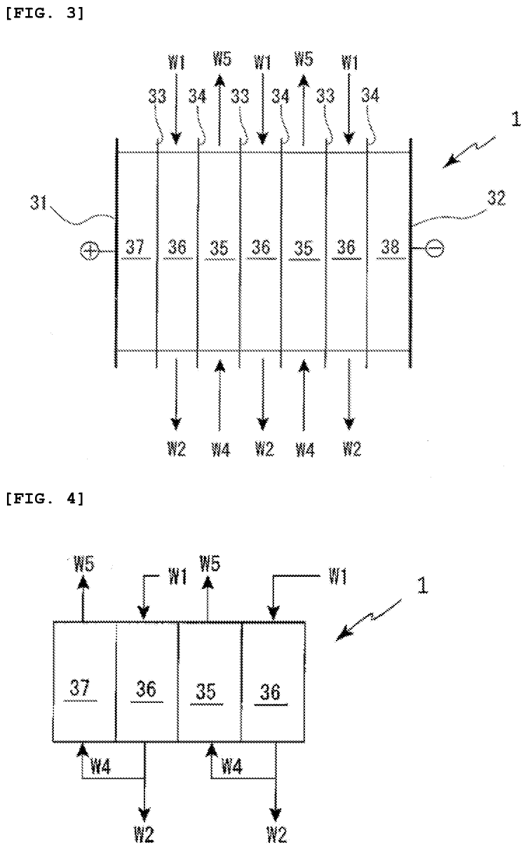

Here, the electrodeionization device having the configuration as illustrated in FIGS. 3 and 4 can be suitably used as the electrodeionization device 1.

In FIG. 3, the electrodeionization device 1 may be configured such that two or more anion exchange membranes 33 and two or more cation exchange membranes 34 are alternately arranged between electrodes (an anode 31 and a cathode 32) to alternately form one or more concentrating chambers 35 and one or more desalting chambers 36. The desalting chambers 36 may be filled with ion exchangers (anion exchangers and cation exchangers) that are mixed or formed in a multi-layered manner. The ion exchangers may be composed of ion exchange resins, ion exchange fibers, graft exchangers, or the like. Likewise, the concentrating chambers 35, an anode chamber 37, and a cathode chamber 38 may also be filled with ion exchangers.

The electrodeionization device 1 may be provided with a water passing means (not illustrated) that passes the supply water W1 through the desalting chambers 36 and takes out the desalted water W2 and a concentrated water passing means (not illustrated) that passes water to be concentrated W4 through the concentrating chambers 35. In the present embodiment, the water to be concentrated W4 may be introduced into the concentrating chambers 35 from the side close to the outlets of the desalting chambers 36 for the desalted water W2, and the concentrated water W5 may be drained from the concentrating chambers 35 close to the inlets of the desalting chambers 36 for the supply water W1. That is, in the configuration of the present embodiment, the water to be concentrated W4 may be introduced into the concentrating chambers 35 from the opposite direction to the flow direction of the supply water W1 in the desalting chambers 36, and the concentrated water W5 may be drained also in that direction. In the present specification, for descriptive purposes, the supply water to the electrodeionization device 1, which may be obtained by processing the pretreated water W1 through the reverse osmosis membrane device 5, the degassing membrane device 6, and the ultraviolet oxidation device 7, is also described as the supply water W1.

The supply water W1 to the desalting chambers 36 can be used as the water to be concentrated W4 which is introduced into the concentrating chambers 35, but as illustrated in FIG. 4, it may be preferred to use, as the water to be concentrated W4, the desalted water W2 obtained from the desalting chambers 36.

### (Control Method for Electrodeionization Device)

The description will now be made as to a control method for the electrodeionization device 1 according to the present embodiment.

The control method for the electrodeionization device 1 according to the present embodiment includes stepwise decreasing the flow rate of the supply water W1 supplied to the electrodeionization device 1 while maintaining a constant flow rate of the concentrated water W5 discharged from the electrodeionization device 1. According to this control method, it is possible to prevent an increase in the electrical conductivity of the concentrated water W5, thereby suppressing the occurrence of scale.

As described above, the control method for the electrodeionization device 1 according to the present embodiment includes stepwise decreasing the flow rate of the supply water W1 supplied to the electrodeionization device 1. As illustrated in FIG. 2, the supply water W1 is supplied to the electrodeionization device 1 via the water supply pump 8 whose flow rate is controllable. The flow rate of the supply water W1 to the electrodeionization device 1 may be decreased stepwise using a pump inverter (not illustrated) or the like attached to the water supply pump 8.

In the control method according to an embodiment, the flow rate of the supply water W1 to be decreased in one step may be preferably 10% or less of the maximum flow rate in the electrodeionization device 1. From another aspect, the flow rate of the supply water W1 to be decreased in one step may be preferably 1% or more of the maximum flow rate in the electrodeionization device 1. If the flow rate of the supply water W1 to be decreased in one step is larger than 10%, the ion concentration of the concentrated water W5 will increase and scale may occur. As a more specific example of the process of decreasing the supply water W1, when the maximum flow rate in the electrodeionization device 1 is 5.0 L/min, the flow rate can be decreased stepwise, such as through 4.5 L/min, 4.0 L/min, 3.5 L/min, and 3.0 L/min. The amount of decrease in the flow rate of the supply water W1 in each step may not necessarily have to be constant, and the amount of decrease in the supply water W1 in each stage may vary within the above range. Additionally or alternatively, the total amount of decrease in the flow rate of the supply water W1, which is the sum of the amount of decrease in the flow rate of the supply water W1 in all steps, may be preferably 70% or less of the flow rate before the decrease in the supply water W1 is started.

In the control method according to an embodiment, the time for one step when stepwise decreasing the flow rate of the supply water W1 supplied to the electrodeionization device 1 may be preferably 1 to 10 minutes. Being within the above range provides an effect that an increase in the ion concentration of the concentrated water W5 can be suppressed. As a more specific example, when the flow rate of the supply water W1 is decreased stepwise through 5.0 L/min, 4.5 L/min, 4.0 L/min, 3.5 L/min, and 3.0 L/min as described above, for example, the flow rate can be maintained at 5.0 L/min for 10 minutes, then reduced to 4.5 L/min and maintained for 10 minutes in this state, then reduced to 4.0 L/min and maintained for 10 minutes in this state, then reduced to 3.5 L/min and maintained for 10 minutes in this state, and then reduced to 3.0 L/min and maintained for 10 minutes in this state.

In the control method according to the present embodiment, the flow rate of the concentrated water W5 discharged from the electrodeionization device 1 is controlled so as to be maintained constant. This can be achieved such that, as illustrated in FIG. 2, for example, the control device 28 controls the control valve 23 and the control valve 26 in accordance with the change in the amount of supplied water W1 to control the flow rates of the desalted water W2 and concentrated water W5 in the electric deionization device 1. That is, the amount of desalted water (primary pure water) W2 may be adjusted so that the recovery rate varies while the amount of concentrated water W5 is constant. Here, being “maintained constant” means that the change in the flow rate of the concentrated water W5 discharged from the electrodeionization device 1 falls within a range of 90% to 110%.

Additionally or alternatively, in the control method according to an embodiment, the water recovery amount of the electrodeionization device 1 may be, but is not particularly limited to, preferably 50% to 99%.

In the control method according to an embodiment, the electrical conductivity of the supply water W1 supplied to the electrodeionization device 1 may be, but is not particularly limited to, preferably 0.1 to 5 mS/m. Additionally or alternatively, the current efficiency of the supply water W1 to the electrodeionization device 1 may be preferably 1% to 30%.

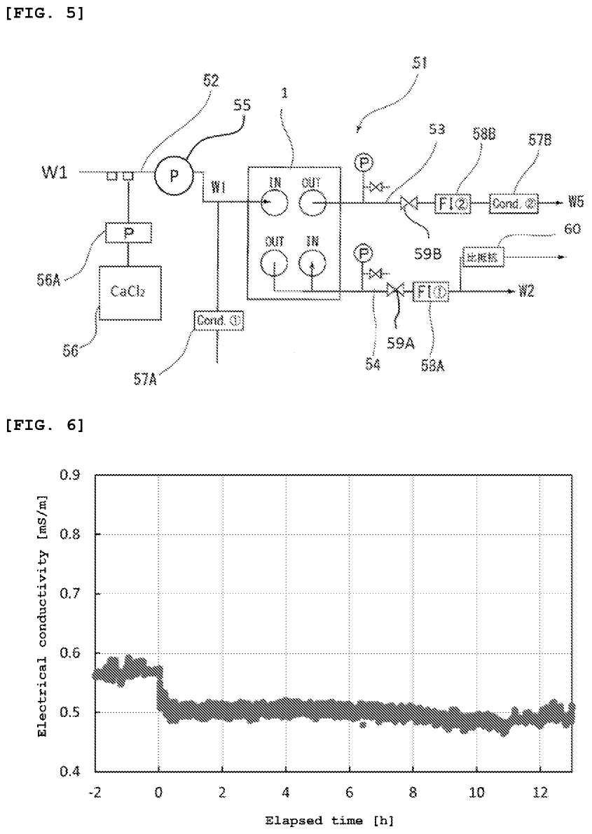

In the control method according to an embodiment, the flow rate of the supply water W1 supplied to the electrodeionization device 1 may be decreased stepwise by PID (Proportional-Integral-Differential) control. For example, the flow rate of the supply water W1 supplied to the electrodeionization device 1 can be reduced stepwise, for example, through measuring the amount of water stored in the sub-tank 11 illustrated in FIG. 2 and/or the flow rate of the desalted water W2 flowing through a desalted water flow path 54 illustrated in FIG. 5 and PID-controlling the output of the water supply pump 8 of FIG. 2 and/or a water supply pump 55 of FIG. 5.

### EXAMPLES

Hereinafter, the present invention will be more specifically described with reference to examples, but the present invention is not limited to the following examples.

### Example 1

Experiments were conducted using a testing device 51 for controlling an electrodeionization device 1 illustrated in FIG. 5. This testing device 51 has a supply water flow path 52, a concentrated water flow path 53, and a desalted water (primary pure water) flow path 54 in addition to the electrodeionization device 1. The supply water flow path 52 is connected to a water supply pump 55 for controlling the flow rate of the supply water W1 to the electrodeionization device 1 and also connected to a calcium chloride solution tank 56 as a calcium ion source via a chemical solution pump 56A, and is provided with a conductivity meter 57A. The concentrated water flow path 53 is provided with a control valve 59B and a flowmeter 58B for controlling the flow rate to an arbitrary amount and is connected to a conductivity meter 57B. The desalted water flow path 54 is provided with a control valve 59A and a flowmeter 58A and is connected to a specific resistance meter 60. The electrodeionization device having the configuration illustrated in FIGS. 3 and 4 was adopted as the electrodeionization device 1.

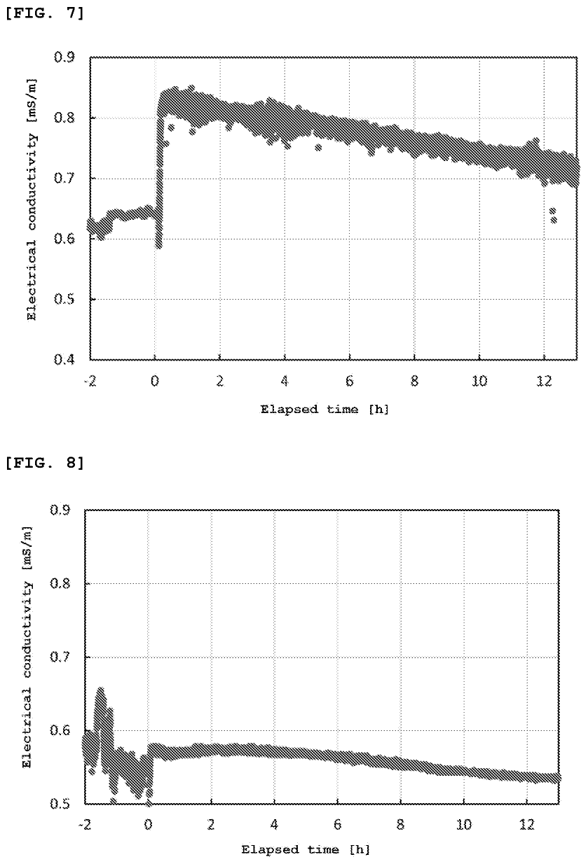

During the operation of the above-described testing device 51, the flow rate of the supply water W1 supplied to the electrodeionization device 1 using the water supply pump 55 was decreased stepwise so as to be 5.0 L/min, 4.5 L/min, 4.0 L/min, and 3.5 L/min every 10 minutes while the flow rate of the concentrated water W5 discharged from the electrodeionization device 1 was maintained at a constant value (1.0 L/min) using the control valve 59A and the control valve 59B. Changes over time due to this operation in the electrical conductivity (mS/m) of the concentrated water W5 flowing through the concentrated water path 53 were measured using the conductivity meter 57B. The results are illustrated in FIG. 6. The above operation was started at a time point 0 of the elapsed time in the graph (the same applies to FIGS. 7 to 9). The current value of the electrodeionization device 1 during the test was 4.0 A, the calcium concentration in the supply water W1 after addition of calcium chloride was 400 μg/L as CaCO₃, and the electrical conductivity of the supply water W1 was within a range of 0.10 to 0.12 mS/m.

### Comparative Example 1

The test of Comparative Example 1 was conducted using the same testing device 51 as in Example 1. During the operation of the testing device 51, the flow rate of the supply water W1 supplied to the electrodeionization device 1 was instantaneously decreased from 5.0 L/min to 3.5 L/min while the flow rate of the concentrated water W5 discharged from the electrodeionization device 1 was instantaneously decreased from 1.0 L/min to 0.7 L/min. Changes over time due to this operation in the electrical conductivity (mS/m) of the concentrated water W5 flowing through the concentrated water path 53 were measured using the conductivity meter 57B. The results are illustrated in FIG. 7. Other conditions are the same as in Example 1.

### Comparative Example 2

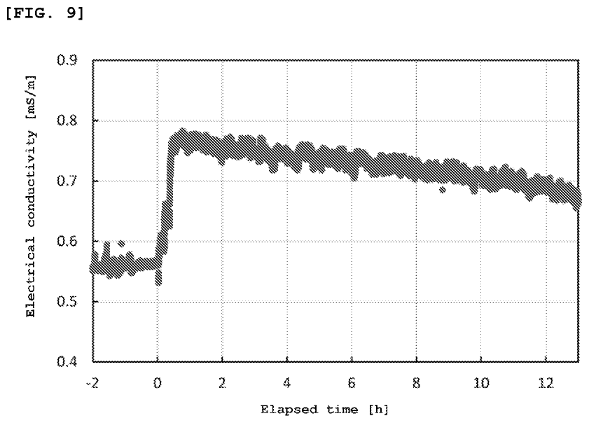

The test of Comparative Example 2 was conducted using the same testing device 51 as in Example 1. During the operation of the testing device 51, the flow rate of the supply water W1 supplied to the electrodeionization device 1 was instantaneously decreased from 5.0 L/min to 3.5 L/min while the flow rate of the concentrated water W5 discharged from the electrodeionization device 1 was maintained at a constant value (1.0 L/min). Changes over time due to this operation in the electrical conductivity (mS/m) of the concentrated water W5 flowing through the concentrated water path 53 were measured using the conductivity meter 57B. The results are illustrated in FIG. 8. Other conditions are the same as in Example 1.

### Comparative Example 3

The test of Comparative Example 3 was conducted using the same testing device 51 as in Example 1. During the operation of the testing device 51, the flow rate of the concentrated water W5 discharged from the electrodeionization device 1 was decreased stepwise so as to be 1 L/min, 0.9 L/min, 0.8 L/min, and 0.7 L/min every 10 minutes. Likewise, the flow rate of the supply water W1 supplied to the electrodeionization device 1 was also decreased stepwise so as to be 5.0 L/min, 4.5 L/min, 4.0 L/min, and 3.5 L/min every 10 minutes. Changes over time due to this operation in the electrical conductivity (mS/m) of the concentrated water W5 flowing through the concentrated water path 53 were measured using the conductivity meter 57B. The results are illustrated in FIG. 9. Other conditions are the same as in Example 1.

### RESULTS AND CONSIDERATION

As apparent from FIGS. 6 to 9, in Example 1, no increase in the electrical conductivity of the concentrated water W5 due to the operation was observed, but in Comparative Examples 1 to 3, the electrical conductivity of the concentrated water W5 increased due to the operation. That is, according to the control method for the electrodeionization device 1 of Example 1, it is possible to prevent an increase in the electrical conductivity and thereby to suppress the occurrence of scale. On the other hand, in the control methods of Comparative Examples 1 to 3, the electrical conductivity of the concentrated water W5 increases, so the possibility of occurrence of scale increases.

The aforementioned embodiments are described to facilitate understanding of the present invention and are not described to limit the present invention. It is therefore intended that the elements disclosed in the above embodiments include all design changes and equivalents to fall within the technical scope of the present invention.

### DESCRIPTION OF REFERENCE NUMERALS

A Ultrapure water production apparatus
1 Electrodeionization device
2 Pretreatment device
3 Primary pure water production device
4 Secondary pure water production device (subsystem)
5 Reverse osmosis membrane device
6 Degassing membrane device
7 Ultraviolet oxidation device
8 Water supply pump
9 DC power supply
11 Sub-tank
12 Ultraviolet oxidation device
13 Non-regenerative mixed bed type ion exchange device
14 Ultrafiltration (UF) membrane
15 Point of use
21 Level switch (water level measuring means)
22 Flow path for desalted water
23, 26 Control valve
24, 27 Flowmeter
25 Flow path for concentrated water
28 Control device
31 Anode (electrode)
32 Cathode (electrode)
33 Anion exchange membrane
34 Cation exchange membrane
35 Concentrating chamber
36 Desalting chamber
51 Testing device
52 Supply water flow path
53 Concentrated water flow path
54 Desalted water flow path
55 Water supply pump
56 Calcium chloride solution tank
56A Chemical solution pump
57A, 57B Conductivity meter
58A, 58B Flowmeter
59A, 59B Control valve
60 Specific resistance meter
W Raw water
W1 Pretreated water (supply water)
W2 Primary pure water (desalted water)
W3 Ultrapure water (secondary pure water)
W4 Water to be concentrated
W5 Concentrated water

1. A control method for an electrodeionization device, comprising
stepwise decreasing a flow rate of supply water supplied to the electrodeionization device while maintaining a constant flow rate of concentrated water discharged from the electrodeionization device.

2. The control method for an electrodeionization device according to claim 1, wherein the flow rate of the supply water to be decreased in one step is 10% or less of a maximum flow rate in the electrodeionization device.

3. The control method for an electrodeionization device according to claim 1, wherein a time for one step when stepwise decreasing the flow rate of the supply water is 1 to 10 minutes.

4. The control method for an electrodeionization device according to claim 1, wherein the flow rate of the supply water supplied to the electrodeionization device is stepwise decreased by PID control.

5. The control method for an electrodeionization device according to claim 2, wherein a time for one step when stepwise decreasing the flow rate of the supply water is 1 to 10 minutes.

6. The control method for an electrodeionization device according to claim 2, wherein the flow rate of the supply water supplied to the electrodeionization device is stepwise decreased by PID control.

7. The control method for an electrodeionization device according to claim 3, wherein the flow rate of the supply water supplied to the electrodeionization device is stepwise decreased by PID control.

8. The control method for an electrodeionization device according to claim 5, wherein the flow rate of the supply water supplied to the electrodeionization device is stepwise decreased by PID control.
